(19) United States
(12) Patent Application Publication
(10) Pub. No.: US 2020/0249066 A1
(43) Pub. Date: Aug. 6, 2020

(54) DISPENSE SENSOR DEVICE

(71) Applicant: Nectar, Inc., Palo Alto, CA (US)

(72) Inventors: Prabhanjan C. Gurumohan, Mountain View, CA (US); Aayush Phumbhra, Palo Alto, CA (US); Samuel Bae, San Jose, CA (US); Nicholas Fraser, Union City, CA (US); Sheshagiri Shenoy, Sunnyvale, CA (US); Cedric Lecroc, Miami, FL (US)

(21) Appl. No.: 16/781,997

(22) Filed: Feb. 4, 2020

Related U.S. Application Data
(60) Provisional application No. 62/801,232, filed on Feb. 5, 2019.

(51) Int. Cl. G01F 15/06; B67D 1/08

(52) U.S. Cl. CPC G01F 15/063; B67D 1/0855

(57) ABSTRACT

A device includes a coupling component configured to be coupled to a moveable component of a content dispensing mechanism. The device includes a sensor configured to detect movement of the content dispensing mechanism. The device includes a processor configured to, based at least in part on the detected movement of the content dispensing mechanism, determine one or more values corresponding to an amount of content dispensed by the content dispensing mechanism. The device includes a wireless signal transmitter configured to report the one or more values corresponding to the amount of content dispensed by the content dispensing mechanism.

### CROSS REFERENCE TO OTHER APPLICATIONS

This application claims priority to U.S. Provisional Patent Application No. 62/801,232 entitled DISPENSE SENSOR DEVICE filed Feb. 5, 2019 which is incorporated herein by reference for all purposes.

### BACKGROUND OF THE INVENTION

Certain items such as beverages and other liquids are often dispensed from large product containers. If the container is transparent, a user can perform a visual check to inventory contents remaining in the containers. However, it is not possible to perform a visual check for many types of non-transparent containers. A user can pick up these containers to determine fill level based on its weight if the container is small and light enough, but often these containers are too large and heavy to be easily handled. Thus the inventory of content remaining in product containers has been traditionally determined manually. This manual process is often imprecise and error prone. For example, it is often difficult for a person to determine the exact amount of liquid beverage remaining in a container with precision in a reliable manner. In commercial settings, the imprecise inventory tracking may lead to incorrect inventory ordering and forecasting.

### BRIEF DESCRIPTION OF THE DRAWINGS

Various embodiments of the invention are disclosed in the following detailed description and the accompanying drawings.

FIG. 1 is a block diagram illustrating an embodiment of a system for an automated container content management environment.

FIG. 2 is a diagram illustrating an example of a beverage faucet and components of the beverage faucet.

FIG. 3 is a diagram illustrating an embodiment of a sensor device that can be coupled to a beverage faucet.

FIG. 4 is a diagram illustrating an embodiment of a sensor device that can be coupled to a beverage faucet.

FIG. 5 is a diagram illustrating an embodiment of a sensor device that can be coupled to a beverage faucet.

FIG. 6 is a diagram illustrating an embodiment of a sensor device that can be coupled to a beverage faucet.

FIG. 7 is a diagram illustrating an embodiment of a sensor device that can be coupled to a beverage faucet.

FIG. 8 is a flowchart illustrating an embodiment of a process for utilizing a sensor device to detect and report a value corresponding to an amount of content dispensed.

FIG. 9 is a flowchart illustrating an embodiment of a process for initializing a sensor device.

FIG. 10 is a flowchart illustrating an embodiment of a process for utilizing a sensor device to detect a value corresponding to an amount of content dispensed.

FIG. 11 is a flowchart illustrating an embodiment of a process for determining an amount remaining in the container.

FIG. 12 is a flowchart illustrating an embodiment of a process for performing inventory management and reporting.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A sensor device is disclosed. In some embodiments, the sensor device is installed onto a content (e.g., liquid) dispensing mechanism and detects an amount of content dispensed. In some embodiments, a sensor device includes a coupling component configured to be coupled to a moveable component (e.g., lever) of a content dispensing mechanism. A sensor of the sensor device detects movement of the moveable component of the content dispensing mechanism. Based at least in part on the detected movement of the moveable component by the sensor, a value corresponding to an amount of content dispensed by the content dispensing mechanism is determined. The sensor device includes a wireless signal transmitter that is used to report the value corresponding to the amount of content dispensed. For example, the sensor device is retrofitted onto a beverage dispensing faucet and by detecting a movement of a lever of an associated length of time, a value corresponding to an amount of liquid dispensed from the faucet is determined and reported.

In some embodiments, a determined amount of content dispensed from the faucet is used to automatically track an amount of content remaining in a container that dispensed the content and also automatically track an inventory of an item/product of the container. For example, a database tracks an amount of total inventory of the item/product on hand (e.g., the number of full container(s) and amount remaining in partial container(s)) and the database is updated using the amount of content dispensed to track depletion of the item/product.

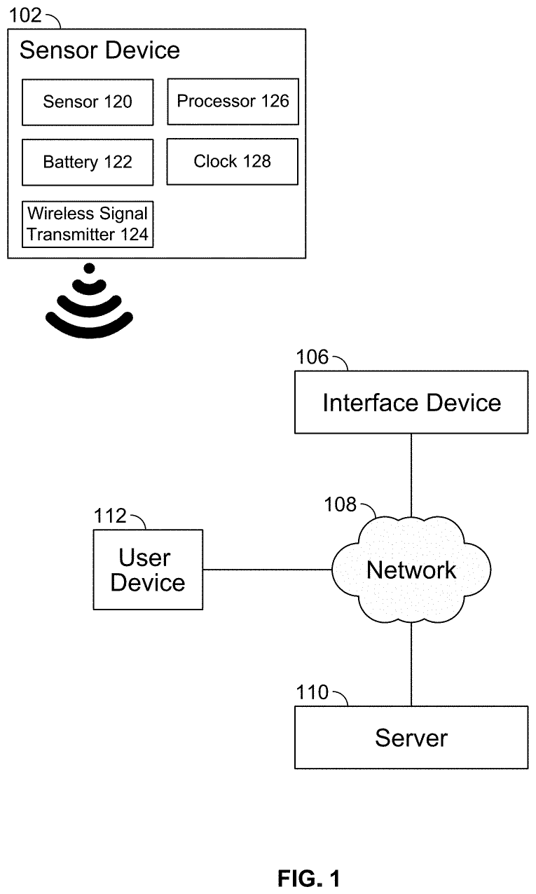

FIG. 1 is a block diagram illustrating an embodiment of a system for an automated container content management environment.

Sensor device 102 includes a sensor for automatically determining the amount of content dispensed from a container. Although only one sensor device has been shown in FIG. 1, any number of sensor devices may exist in various embodiments.

In some embodiments, sensor device 102 is utilized to determine an amount of content (e.g., liquid) dispensed from a tap/faucet/fountain/container/valve dispensing the content. Sensor device 102 includes sensor 120, battery 122, wireless signal transmitter 124, processor 126, and clock 128. These components shown in sensor device 102 are merely an example and some of these components may not exist in various embodiments and other additional components may exist in various embodiments. Battery 122 provides power to sensor device 102. Examples of sensor 120 include an accelerometer, a gyroscope, an orientation sensor, a tilt sensor, a switch, etc. More than one sensor of the same or different type may exist in various different embodiments. In some embodiments, sensor device 102 includes a temperature sensor. In some embodiments, sensor device 102 includes a button. The button may be processed to turn on the sensor device and/or initiate a pairing process with the sensor device with user device 112 or interface device 106.

Given flow rate information, a position of a dispense lever/handle detected by the sensor device based on a detected angle position (e.g., detected using sensor 120) of the sensor device can be used to determine (e.g., using processor 126) an amount of content dispensed from the tap/faucet/fountain/container each time the lever/handle is actuated. For example, the sensor device is utilized to determine a time duration (e.g., measured using clock 128) of a tap being open based on a detected relative angle (e.g., using sensor 120) of the sensor device with respect to closed position angles and open position angles. The sensor device can be mechanically coupled to the tap faucet as a spacer between its handle component and its lever spacer.

In some embodiments, a sensor (e.g., accelerometer, gyroscope, orientation sensor, tilt sensor, switch, etc.) is included in the sensor device that is held vertically in line with the tap faucet handle. As the handle moves to open and close the sensor would detect the movement (e.g., change in position angle, change in orientation, change in switch position, change in position, rate of change of displacement, direction of movement, acceleration of movement, etc.) and the duration of each state. Each tap can be calibrated by determining/specifying the amount poured out during a certain interval the tap is open and at a given displacement. Based on the a priori knowledge, amount dispensed during each drink from the tap can be computed using the time and displacement of the tap.

In various embodiments, sensor device 102 includes one or more of the following features: notification is provided if the sensor device is disabled or removed; is waterproof; is in a battery save mode prior to deployment; provides a notification when the battery is low; is coupled to a dispense system lever; has an ability to remotely update its firmware; has an ability to remotely update its configurations; or has a storage to store measurement data.

Interface device 106 receives data from one or more sensor devices. For example, sensor device 102 broadcasts an identifier of an amount of content remaining in a container covered by sensor device 102 and interface device 106 receives the identifier for storage and processing. In some embodiments, sensor device 102 needs to be configured for a specific type of product/container to allow each sensor device to be able to more accurately measure the amount of content remaining in a container corresponding to the sensor device. For example, a type of liquid, a type of gas, and/or target storage temperature specific to the product may affect the flow/dispense rate of the product from a faucet. In some embodiments, interface device 106 pairs with a sensor device (e.g., via a wireless Bluetooth connection) to transmit configuration data specific to the type of container associated with the sensor device. In some embodiments, a user utilizes interface device 106 to specify the type of container to be associated with a specific sensor device. In some embodiments, a user utilizes interface device 106 to view, manage, and/or configure one or more associated sensor devices. For example, a user utilizes an application of interface device 106 to configure sensor devices, view an inventory of remaining content measured by sensor devices, and automate ordering of low inventory content. Examples of interface device 106 include a mobile device, a smartphone, a smart watch, a wearable computer, a laptop computer, a desktop computer, and any other type of computer. In some embodiments, the interface device is also a charging station for one or more sensor devices.

In some embodiments, interface device 106 (e.g., base station) acts as a central communication hub for all sensor devices of a user within a certain proximity. For example, sensor devices may communicate with the base station via GATT mode of Bluetooth and/or via advertising mode of Bluetooth. In some embodiments, interface device 106 is associated with a specific user. Multiple interface devices may be utilized to manage the same set of sensor devices. For example, multiple interface devices may communicate with one another and/or with a backend server to synchronize data. In some embodiments, interface device 106 includes BLUETOOTH, BLUETOOTH Low Energy, and/or wireless (402.x) protocol-based wireless chipsets. In some embodiments, interface device 106 includes a display to display sensor device status, beverage quantity, recipes, order reminders, etc. In some embodiments, interface device 106 communicates with a Point of Sales (POS) system to correlate sales data with measured content utilization/consumption/depletion. In various embodiments, interface device 106 (e.g., base station) includes one or more of the following:
a display to inform a user about sensor device status, beverage quantity, recipes, reminders, etc.
a touch sensor or flashing LED-based communicator to pair the sensor devices.
a data storage to store data from thousands of sensor devices for at least a few days to a month.
an ability to communicate with a Point of Sales system.
an ability to communicate with the sensor devices to collect the beverage volumes on demand.
an ability to communicate with the sensor devices to re-pair itself to a new container and provide new configuration parameters.

Interface device 106 is connected to server 110 (e.g., backend server) by network 108. In some embodiments, server 110 remotely stores and/or processes measurement data received from sensor devices. For example, measurement data periodically broadcasted by sensor device 102 is received by interface device 106 and interface device 106 provides the received data to server 110 for storage and/or backend server processing. In some embodiments, interface device 106 and/or server 110 utilizes measurement data of a sensor device to calculate an amount of content remaining in a container engaged by the sensor device. For example, a round trip signal reflection time measured by a sensor device is utilized to calculate a percentage fill amount of content remaining in a container. In some embodiments, server 110 processes current and/or historical content measurements to provide analytics (e.g., consumption patterns, determine inventory, analyze cost of goods sold, identify popularity trends, etc.) and inventory management solutions (e.g., inventory forecasting, inventory planning, automated inventory ordering, etc.). In various embodiments, server 110 provides one or more of the following functionalities:
a storage of beverage related data that offers a view into beverage consumption patterns by service owners: beverage name, types of liquid, brand, UPC or a bar code, quantity, price, distributor, date and time of purchase, servings per use, time of servings consumed, location, expiration, chemical composition, odor, color, temperature, humidity, ingredients used, and various nutrient amounts (e.g., Sulfites, ethyl, carbohydrates, proteins, fats, sugars, etc.).
a mechanism to uniquely associate various devices that help collect beverage data with each user and their inventory.
an ability to listen, collect, and store millions of devices at any given point in time.
an ability to notify the user to reorder the necessary beverages or automatically reorder and replenish from distributors.
an algorithm that analyzes, learns, and predicts amount of beverage/food needed by a user and consumable state of the item (e.g., expiration dates).
an ability to set beverage threshold levels that trigger a notification to reorder.
an ability to provide a notification when the beverage temperature is not ideal and the beverage needs more appropriate storage.
an ability to set thresholds for inventory based on category, brands, type of beverage, and recipes.
an ability to provide real time notifications when the inventory levels fall below threshold levels.

User device 112 is utilized by a user to setup, configure, view and/or otherwise interact with one or more of the components shown in FIG. 1. For example, a user utilizes user device 112 to setup and/or configure one or more of sensor devices 102. In another example, a user utilizes user device 112 to configure, view and/or interact with data and configuration managed, tracked and/or analyzed by server 110. Examples of interface device 106 include a mobile device, a smartphone, a smart watch, a wearable computer, a laptop computer, a desktop computer, and any other type of computer. User device 112 is optional. For example, interface device 106 may include a touchscreen that can be used to perform one or more functions of user device 112. User device 112 is connected network 108 and may communicate with any of the other components shown in FIG. 1 via network 108. User device 112 may also directly communicate directly with one or more of the other components shown in FIG. 1. For example, user device 112 may communicate directly with interface device 106 and/or one or more of sensor devices 102 via a BLUETOOTH connection.

In some embodiments, the system shown in FIG. 1 is utilized in a bar/restaurant environment to automatically track and manage inventory of liquor remaining in liquor bottles. Each liquor bottle is capped using a sensor device that is configured to be a cap for the liquor bottle. In some embodiments, the sensor devices detect the quantity of liquid/beverage remaining in each bottle and broadcast the detected quantity to interface device 106. The interface device reports the received quantity information to server 110. In some embodiments, server 110 provides an online interface to manage container content (e.g., beverage) inventory. For example, a bar/restaurant user entity may access server 110 via an application of interface device 106, user device 112, and/or a webpage interface provided by server 110 to view and manage inventory of one or more tracked beverage products. Inventory information (e.g., including inventory remaining in open containers measured by sensor devices and full bottle inventory on hand in storage) may be updated automatically and viewed and exported in real time. The inventory of products may be classified by brands, drink type (tequila, whiskey, etc.), recipe (e.g., amount of each mixed drink able to be made using remaining inventory), and/or popularity. In various embodiments, the system provides one or more following functions:
a mechanism to export or import the entire inventory of beverages classified by brands, drink type (e.g., tequila, whiskey etc.), recipe, and popularity.
a manual or automated process/technique of marking sensor devices (physically or through software identifiers) for tracking which sensor device corresponds to each of the beverages listed in the tracked inventory.
an ability to register and identify the base station for a particular user account.

In some embodiments, for a specific user account associated with one or more sensor devices, server 110 learns the consumption pattern, nutrients, and preferences in various types of beverages, flavors, taste, and brands. In some embodiments, using interface device 106 and/or user device 112, a user is able to access information about consumption quantity, humidity, oxygen content, inventory, drink recipes, and seasonal recommendations associated with current inventory detected using one or more sensor devices. In some embodiments, using interface device 106 and/or user device 112, a user may access a marketplace to order beverages from various distributors and delivery services. In some embodiments, a user is notified via interface device 106 and/or user device 112 of a need to replenish an inventory of beverages and may also directly notify one or more distributors to place one or more appropriate orders. In some embodiments, interface device 106 and/or user device 112 provides recommendations for various drink recipes based on existing inventory detected using one or more sensor devices. In some embodiments, consumption data obtained across a plurality of different user entities may allow trend analysis and manufacturing forecasting across user entities.

One or more of the following may be included in network 108: a direct or indirect physical communication connection, mobile communication network, Internet, intranet, Local Area Network, Wide Area Network, Storage Area Network, a wireless network, a cellular network, and any other form of connecting two or more systems, components, or storage devices together. Additional instances of any of the components shown in FIG. 1 may exist. For example, server 110 may be a distributed server and/or may be connected to a plurality of interface devices. In another example, a plurality of interface devices may be utilized to manage and/or utilize the same or different container covers. In some embodiments, components not shown in FIG. 1 may also exist.

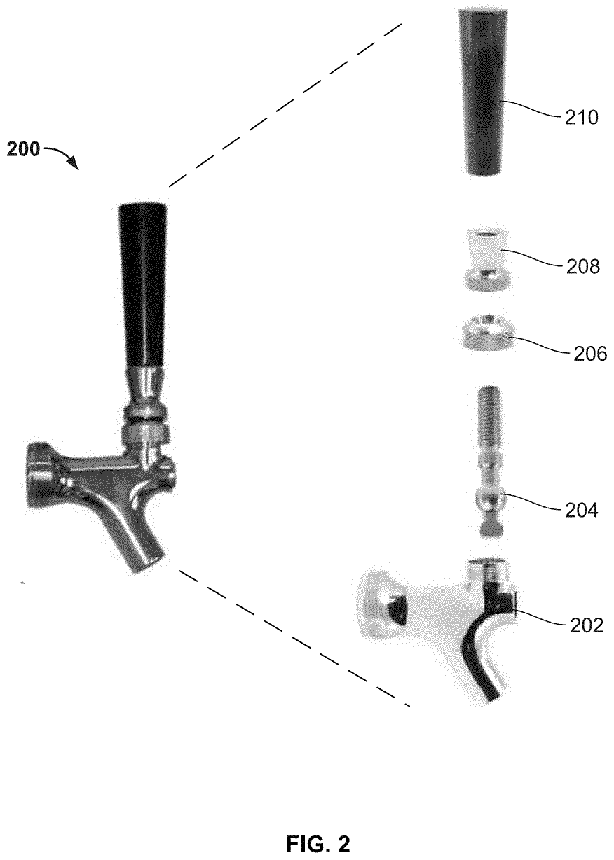

FIG. 2 is a diagram illustrating an example of a beverage faucet and components of the beverage faucet. Beverage faucet 200 is an example of a beverage faucet that can be used to dispense a liquid (e.g., beer, soft drink, coffee, other carbonated beverage, etc.) from a container (e.g., beverage keg). When a handle of the beverage faucet is pulled, a valve opens to allow the beverage under pressure to flow out from the container. Some of the components of faucet 200 are also shown in the exploded view in FIG. 2. Beverage faucet 200 includes faucet body 202, lever component 204, lever bonnet 206, lever collar 208, and handle 210. Lever component 204 is inserted within faucet body 202 and actuates a valve within faucet body 202 to open or close the valve to dispense or stop dispensing content when lever component 204 is moved/pivoted. Lever bonnet 206 screws onto faucet body 202 to retain a portion of lever component 204 within faucet body 202. Lever collar 208 screws onto a threaded end of lever component 204 that goes through lever collar 208. Handle 210 also screws onto the threaded end of lever component 204 and extends the length of the lever of beverage faucet 200.

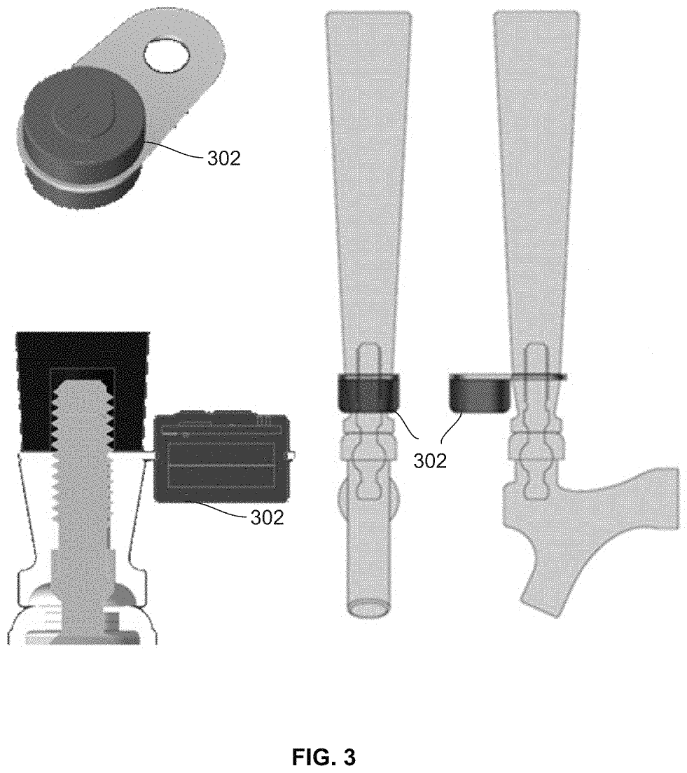

FIG. 3 is a diagram illustrating an embodiment of a sensor device that can be coupled to a beverage faucet. FIG. 3 shows a standalone view of sensor device 302, views of sensor device 302 installed onto a beverage faucet, and a cut-away view as installed onto the beverage faucet. In some embodiments, sensor device 302 is an example of sensor device 102 of FIG. 1. The shown sensor device 302 can be coupled to a lever component of a beverage faucet (e.g., faucet 200 of FIG. 2) between its lever collar component and its handle component. Sensor device 302 includes a flat portion with a hole where a lever component of a faucet can be threaded through. For example, in order to install sensor device 302 onto a beverage faucet, its handle can be screwed off to expose an end of a lever component to be inserted through an opening of sensor device 302. Then the handle component can be screwed back on to secure sensor device 302 onto the lever of the faucet via compression forces between the collar and handle of the faucet.

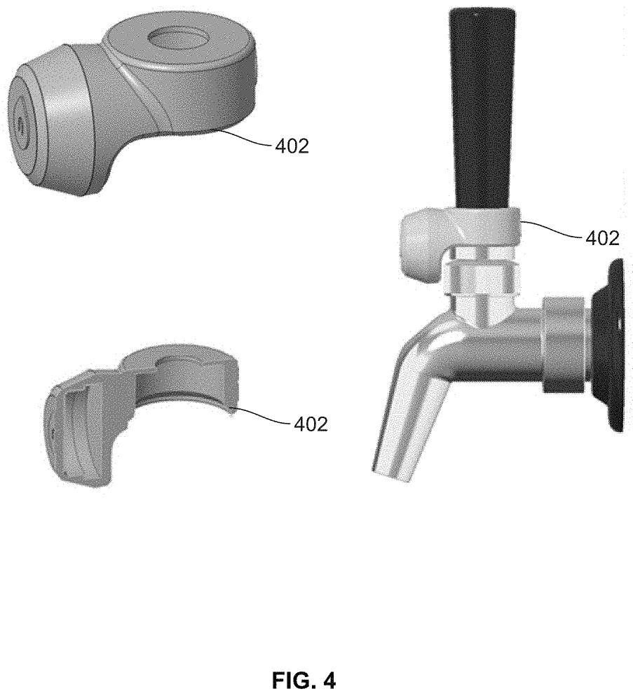

FIG. 4 is a diagram illustrating an embodiment of a sensor device that can be coupled to a beverage faucet. FIG. 4 shows a standalone view of sensor device 402, a view of sensor device 402 installed onto a beverage faucet, and a cut-away view of sensor device 402. In some embodiments, sensor device 402 is an example of sensor device 102 of FIG. 1. The shown sensor device 402 can be coupled to a lever component of a beverage faucet (e.g., faucet 200 of FIG. 2) between its lever collar component and its handle component. Sensor device 402 includes a jacket portion with a hole where a lever component of a faucet can be threaded through. After installation, the jacket portion at least in part goes over and covers a collar component of the faucet. For example, in order to install sensor device 402 onto a beverage faucet, its handle can be screwed off to expose an end of a lever component to be inserted through an opening of sensor device 402. Sensor device 402 is positioned over the collar of the faucet. Then the handle component can be screwed back on to secure sensor device 402 onto the lever of the faucet via compression forces between the collar and handle of the faucet.

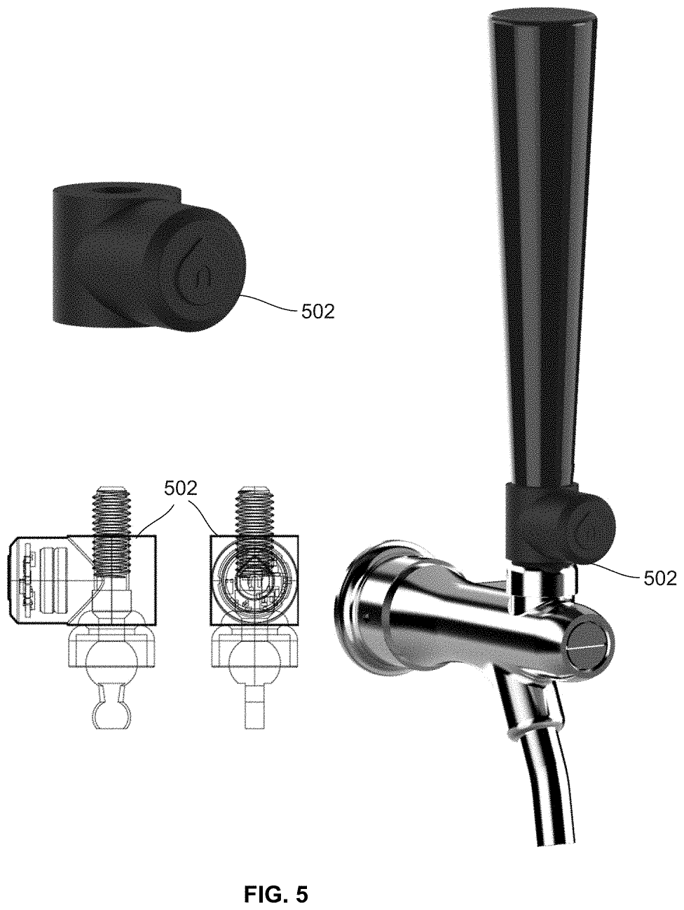

FIG. 5 is a diagram illustrating an embodiment of a sensor device that can be coupled to a beverage faucet. FIG. 5 shows a standalone view of sensor device 502, a view of sensor device 502 installed onto a beverage faucet, and cut-away views as installed onto the beverage faucet. In some embodiments, sensor device 502 is an example of sensor device 102 of FIG. 1. The shown sensor device 502 can be coupled to a lever component of a beverage faucet (e.g., faucet 200 of FIG. 2) between its lever bonnet component and its handle component, effectively serving as a lever collar component. Sensor device 502 includes an opening where a lever component of a faucet can be placed through. For example, in order to install sensor device 502 onto a beverage faucet, its handle and collar can be screwed off to expose an end of a lever component to be inserted (e.g., slid) through the opening of sensor device 502. Then the handle component can be screwed back on to the lever component to secure sensor device 502 onto the lever of the faucet.

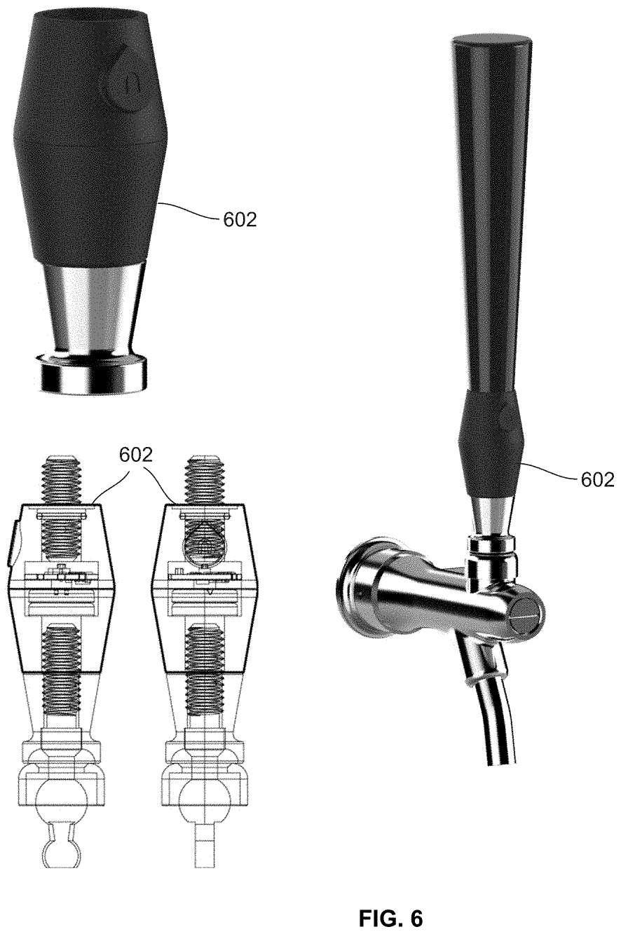

FIG. 6 is a diagram illustrating an embodiment of a sensor device that can be coupled to a beverage faucet. FIG. 6 shows a standalone view of sensor device 602, a view of sensor device 602 installed onto a beverage faucet, and cut-away views as installed onto the beverage faucet. In some embodiments, sensor device 602 is an example of sensor device 102 of FIG. 1. The shown sensor device 602 can be coupled to a lever component of a beverage faucet (e.g., faucet 200 of FIG. 2) between its lever bonnet component and its handle component, effectively serving as a lever collar component and/or a part of a handle component. Sensor device 602 includes a threaded bottom opening that can be screwed onto a lever component of a faucet. Sensor device 602 includes a threaded top opening that can accept a threaded rod. In one example, a threaded rod is screwed into the top opening of sensor device 602 and a handle is screwed onto the other end of the threaded rod. In another example, a handle with the screw end can be screwed into the top opening of sensor device 602.

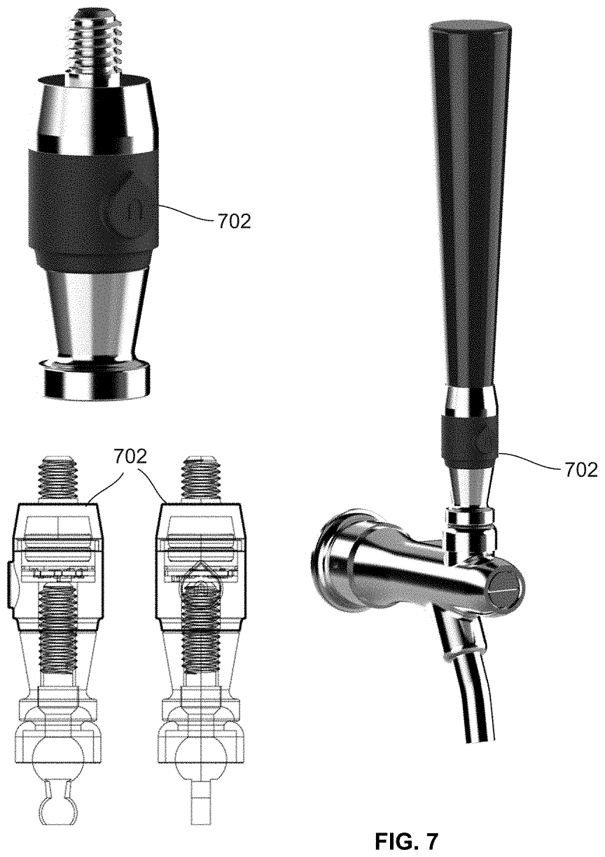

FIG. 7 is a diagram illustrating an embodiment of a sensor device that can be coupled to a beverage faucet. FIG. 7 shows a standalone view of sensor device 702, a view of sensor device 702 installed onto a beverage faucet, and cut-away views as installed onto the beverage faucet. In some embodiments, sensor device 702 is an example of sensor device 102 of FIG. 1. The shown sensor device 702 can be coupled to a lever component of a beverage faucet (e.g., faucet 200 of FIG. 2) between its lever bonnet component and its handle component, effectively serving as a lever collar component and/or a part of a handle component. Sensor device 702 includes a threaded bottom opening that can be screwed onto a lever component of a faucet. Sensor device 702 includes a threaded top screw that can accept a handle component. For example, a handle component is screwed onto the top of sensor device 702.

Although various embodiments of a sensor device that can be coupled to a beverage faucet have been shown in FIGS. 3-7, other embodiments of the sensor device that can be coupled to other content dispensing content mechanisms do exist. For example, sensor device 102 is coupled to a lever of a solid item (e.g., grain) dispensing mechanism to detect the amount of content dispensed. In another embodiment, the sensor device is integrated into a handle component that takes the place of an existing handle of a dispense faucet.

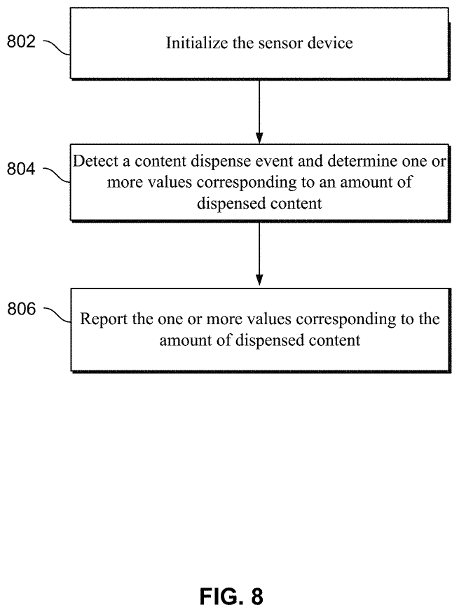

FIG. 8 is a flowchart illustrating an embodiment of a process for utilizing a sensor device to detect and report a value corresponding to an amount of content dispensed. The process of FIG. 8 may be at least in part performed by sensor devices 102, 302, 402, 502, 602, and/or 702 of FIGS. 1 and 3-7.

At 802, the sensor device is initialized. For example, once the sensor device has been installed on a content dispense mechanism, the sensor device is to be initialized to calibrate and/or set up the sensor device for content dispense detection. The initialization may include performing one or more of the following: pairing the sensor device with a user device (e.g., user device 112) and/or interface device (e.g., interface device 106), receiving a specification of a product to be dispensed/tracked using the sensor device, receiving a specification (e.g., size, type, content amount remaining, storage temperature, expiration date, etc.) of a product and/or container of content to be dispensed/tracked using the sensor device, performing a content dispense test to calibrate the sensor device, specifying a type/brand/model of content dispense mechanism that the sensor device is coupled to, etc. One or more aspects of the sensor device initialization may be performed again periodically and/or when needed. For example, the sensor device initialization is performed when a different product is to be tracked using the sensor device. In another example, a content dispense test to calibrate the sensor device may be performed periodically and/or when error is detected.

At 804, a content dispense event is detected and one or more values corresponding to an amount of dispensed content are determined. A position of a dispense lever/handle detected by the sensor device based on a detected angle/position of the sensor device can be used to determine an amount of content dispensed from the tap/faucet/fountain/container each time the lever/handle is actuated.

A sensor of the sensor device detects that a content is being dispensed. For example, the sensor detects that the content dispense event has started based on a detected position, angle, switch state, rate of change of movement, acceleration of movement, direction of movement, orientation, tilt, location, and/or movement signature. In some embodiments, it is determined that a content dispense event has begun if a magnitude and/or position of a detected movement of the sensor device meets a triggering threshold corresponding to dispensing of content from the content dispensing mechanism that the sensor device is coupled to. The triggering threshold may be in various embodiments a range, a specified value (e.g., specified angle or position value), or a relative percentage of a movement range of a lever. For example, the sensor is an accelerometer and a content dispense event is detected when an orientation angle of the sensor changes by at least a threshold amount from an initial closed position to be at or beyond a threshold dispense angle corresponding to the opening of a valve to dispense content from the content dispense mechanism (e.g., lever of beverage faucet is detected as pulled/rotated to open the faucet to dispense beverage). Then the amount of time (i.e., dispense time) to an end of the content dispense event can be measured. It is determined that the content dispense event has ended if the magnitude and/or position of a detected movement of the sensor device no longer meets the triggering threshold corresponding to dispensing of content. For example, the sensor is an accelerometer and an end of the content dispense event is detected when the detected position, angle, switch state, orientation, tilt, location, and/or movement signature of the sensor changes back to a position associated with the stopping of a content dispense (e.g., lever of beverage faucet is detected as pushed/rotated back to close the faucet and place an angle of the sensor to no longer be within a range of angles corresponding to dispensing of content).

If the flow rate of content is known, the total amount of content dispensed can be calculated by multiplying the flow rate by the determined amount of dispense time. In some embodiments, the one or more values corresponding to the amount of dispensed content include a duration time value (e.g., the determined amount of dispense time). In some embodiments, the one or more values corresponding to the amount of dispensed content includes a content amount value (e.g., volume, weight, count, etc.). In some embodiments, a flow rate of content is different for different lever/handle positions and the one or more values corresponding to the amount of dispensed content include a value for each different detected lever/handle position during the content dispense event. For example, a duration time for each different detected sensor position/angle while the detected sensor position/angle is within a range to dispense content is included in the one or more values corresponding to the amount of dispensed content.

At 806, the one or more values corresponding to the amount of dispensed content are reported. In some embodiments, the sensor device sends a wireless packet (e.g., using Bluetooth Low Energy or another local/personal wireless signal). For example, the one or more values (e.g., log of time duration values for different sensor movement measurements) are wirelessly transmitted to a user device (e.g., user device 112) or an interface device (e.g., interface device 106) to report the content dispense event. In addition to these values, other information may be reported. Examples of these other information include a device temperature value, a liquid temperature value, a current time value, a flow rate, a count value, an iteration value, a device identifier, or a product identifier. The reported one or more values may be utilized to track and manage inventory of content remaining in a container in use as well as new container inventory. For example, when an amount of inventory of a product reaches below a threshold, a new product container is automatically reordered.

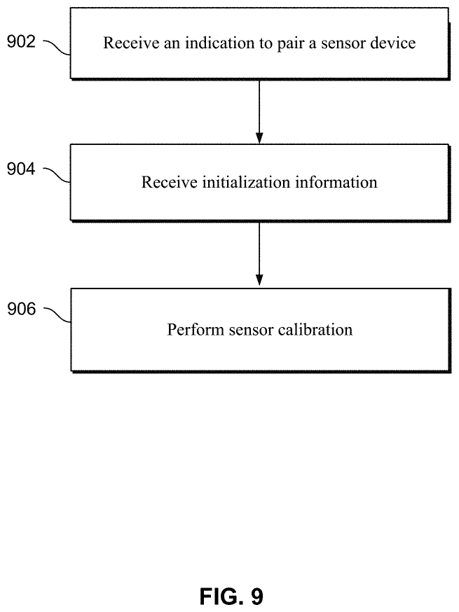

FIG. 9 is a flowchart illustrating an embodiment of a process for initializing a sensor device. The process of FIG. 9 may be at least in part performed by user device 112 or interface device 106 of FIG. 1 to initialize sensor devices 102, 302, 402, 502, 602, and/or 702 of FIGS. 1 and 3-7. In some embodiments, at least a portion of the process of FIG. 9 is performed in 802 of FIG. 8.

At 902, an indication to pair a sensor device is received. For example, after the sensor device is installed on a content dispensing mechanism (e.g., on a lever of the content dispensing mechanism), a user presses a button on the sensor device to initiate a paring/registration process (e.g., sensor device enters 2 way communication mode and broadcasts an identification signal). This signal is detected by the receiving device (e.g., user device or interface device) and using a user interface, a user initializes and performs a setup of the sensor device. In some embodiments, the paring/registration process may be performed again when the sensor device is installed on a different content dispensing mechanism. Based on the indication, the sensor device pairs with a receiving device that will be utilized to manage and/or receive measurements from the sensor device.

At 904, initialization information is received. For example, information associated with the content dispensing mechanism, content dispensing environment, content/product to be dispensed, container to be tracked, and/or product to be tracked is received. In some embodiments, the received information includes specifications of a product to be dispensed/tracked using the sensor device, a container (e.g., size, type, content amount remaining, storage temperature, expiration date, etc.) of content to be dispensed/tracked using the sensor device, and/or a type/brand/model of content dispense mechanism that the sensor device is coupled to. The collected information links the sensor device to a specific product and/or container to be tracked and assists in capturing a current state of inventory. Additionally because the flow/dispense rate of content can vary based on a variety of factors (e.g., product being dispensed, type/model of content dispensing mechanism, temperature of product, pressurization of the product, etc.), the collected information can be utilized to improve the accuracy of the determined dispensed amounts. In some embodiments, to specify the product being tracked using the sensor device, a user scans/captures (e.g., picture) a UPC/QR code or a label on a container of the product being tracked, and the received image or code is analyzed to automatically identify the product and/or container of the product to be associated with the sensor device. In some embodiments, a current fill level/amount of the container from which content is to be dispensed using the dispense mechanism coupled to the sensor device is received (e.g., percentage value, weight value, volume value, etc.). A user may later provide updated initialization information when a different product and/or new/replacement container is to be tracked using the sensor device.

At 906, sensor calibration is performed. For example a calibration factor specific to the sensor device for the product being tracked by the sensor device is determined. In some embodiments, a user is instructed to confirm when the dispense mechanism coupled to the sensor device is in an off position (e.g., to identify the reference position/angle of the sensor device when no content is being dispensed). In some embodiments, a user is instructed to confirm when the dispense mechanism coupled to the sensor device is in a rest/off position (e.g., to identify the reference position/angle of the sensor device when no content is being dispensed). In some embodiments, a user is instructed to move a lever of the content dispense mechanism through a full range of motion (e.g., to identify the possible positions/angles of the sensor device). In some embodiments, a user is instructed to move a lever of the content dispense mechanism a minimal amount to trigger dispensing of content (e.g., to identify the threshold position/angle of the sensor device when content is being dispensed). In some embodiments, a user is instructed to dispense a specified known amount and a value reported from the sensor device corresponding to the amount dispensed is used to calibrate the measurement of the sensor device. The calibration process may be repeated for the same specified known amount or different amounts (e.g., a pint, a pitcher, etc.) to obtain multiple values reported from the sensor device for different measurements to improve the accuracy of the calibration. For example, a calibration factor is determined and stored to be utilized in determining a quantity of content dispensed during a dispense event. In some embodiments, the calibration factor is sent to the sensor device.

Determining the calibration factor may include determining a difference between an expected value (e.g., based on historical values or baseline expected values for the specific product) and a measured/reported value from the sensor device. In some embodiments, determining the calibration factor includes fitting/adjusting a known dispense rate or value curve/profile for the specific product being dispensed to the one or more values measured/determined using the calibration process and utilizing the adjusted curve/profile as the calibration factor.

In some embodiments, determining the calibration factor includes using machine learning. For example, a machine learning model is trained based on seeded values as well as measured values from the calibrations to output a model that outputs a calibrated value based on an input value reported from the sensor device. This model may be continually trained to improve its performance. For example, beverages are typically poured and sold in certain quantities (e.g., pint) and reported values from the sensor device can be correlated with expected values for the certain quantities to further train and improve the model.

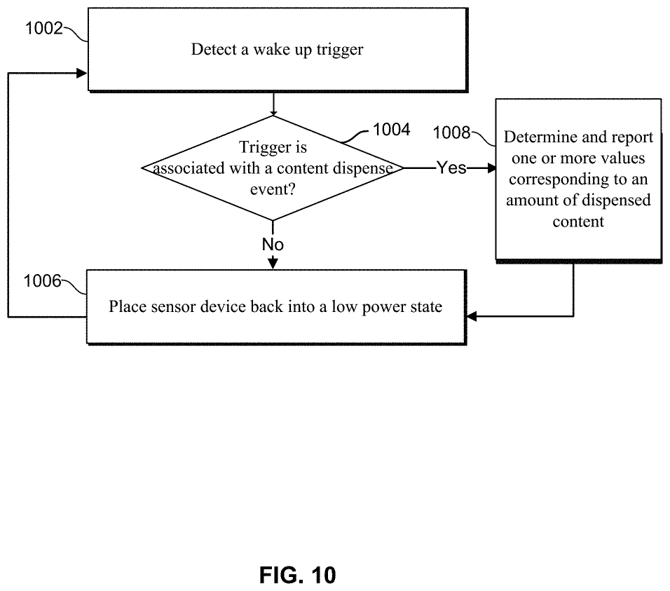

FIG. 10 is a flowchart illustrating an embodiment of a process for utilizing a sensor device to detect a value corresponding to an amount of content dispensed. The process of FIG. 10 may be at least in part performed by sensor device 102, 302, 402, 502, 602, and/or 702 of FIGS. 1 and 3-7. In some embodiments, at least a portion of the process of FIG. 10 is performed in 804 of FIG. 8.

At 1002, a wake up trigger is detected. The sensor device may be powered by a battery and the sensor device enters a low power state (e.g., certain components turned off or in reduced operational state) in order to conserve power. When a content dispense event is taking place the sensor device should exit out of the low power state to detect and process the content dispense event. The sensor device wakes up from a low power state when a trigger is detected to determine whether to fully exit out of the low power state. In some embodiments, the wake up trigger is a detected movement of another sensor trigger of the sensor device.

At 1004, it is determined whether the detected trigger is associated with a content dispense event. For example, because the detected movement may be due to an extraneous vibration or other non-eventful movement, it is determined whether the detected movement meets a criteria indicative of a content dispense event. In some embodiments, it is determined that the detected trigger is associated with a content dispense event if a magnitude and/or position of a detected movement of the trigger meets a triggering threshold corresponding to dispensing of content from the content dispensing mechanism that the sensor device is coupled to. For example it is determined that the detected trigger meets a triggering threshold if a detected position (e.g., orientation, tilt angle, or location) is within a range associated with dispensing of content (e.g., is greater than a threshold value). In another example it is determined that the detected trigger meets a triggering threshold if a detected magnitude of movement (e.g., change in orientation, tilt angle, or location) is within a range associated with dispensing of content (e.g., is greater than a threshold value). It is determined that the detected trigger is not associated with a content dispense event if the magnitude and/or position of a detected movement of the trigger does not meet the triggering threshold corresponding to dispensing of content. The triggering threshold may be, in various embodiments, a range, a specified value (e.g., specified angle or position value), or a relative percentage of a movement range of a lever.

If at 1004 it is determined that the detected trigger is not associated with a content dispense event, at 1006 the sensor device is placed back into a low power state.

If at 1004 it is determined that the detected trigger is associated with a content dispense event, at 1008 one or more values corresponding to an amount of dispensed content are determined and reported. For example, at least a portion of the steps of 804 and 806 of the process of FIG. 8 is performed. The process returns back to 1006.

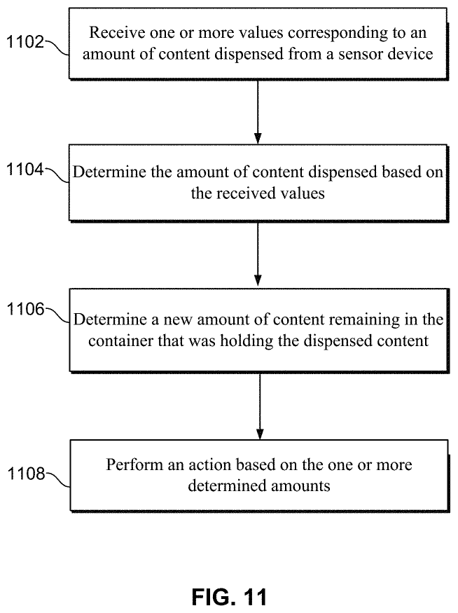

FIG. 11 is a flowchart illustrating an embodiment of a process for determining an amount remaining in the container. The process of FIG. 11 may be at least in part implemented on interface device 106, user device 112, and/or server 110 of FIG. 1.

At 1102, one or more values corresponding to an amount of content dispensed is received from a sensor device. For example, the received values are reported values from 806 of FIG. 8 and/or 1008 of FIG. 10. The values may include one or more time duration values at one or more corresponding detected sensor positions of the sensor device.

At 1104, the amount of content dispensed is determined based on the received values. For example, if one overall time duration is reported, the time is multiplied with a corresponding flow rate to convert the time duration value to a total volume/amount. If a plurality of time values at different indicated detected sensor positions is reported, each time value is multiplied with a corresponding flow rate at the corresponding indicated detected sensor position and results are summed to convert the time duration values to a total volume/amount dispensed value. The one or more flow rates may also depend on various factors such as the specific product being dispensed, type/brand/model of content dispense mechanism that the sensor device is coupled to, properties of the container that was holding the dispense contents (e.g., size, type, content amount remaining, pressure, storage temperature, expiration date, etc.), temperature of the contents, pressurization type/level, etc. Thus the flow rate to be utilized is determined/adjusted based on one or more of these factors. For example, the liquid poured could vary as the keg empties out unless a constant pressure is maintained. This is usually maintained using CO₂ cylinders that pump CO₂ into the keg and a constant pressure (PSI) that pushes out the beer at a certain rate. Nitrogen is used in the case of stouts. In some embodiments, by tracking the previous amount of content remaining in the keg/container and/or the reduction in pressure, a reduction in associated flow rate is automatically determined and utilized in determining an amount of dispensed content. In some cases, temperature variations could cause pressure to vary and hence the rate of displacement could vary and even the quality of pour could be impacted due to foaming. In some embodiments, temperature of a container and/or contents is measured and/or received to determine an associated flow rate utilized in determining an amount of dispensed content.

In some embodiments, the flow rate and/or the time duration is adjusted based on one or more calibration factors determined in 906 of FIG. 9. For example, a flow rate determined for a specific product is multiplied by a determined calibration factor to determine a calibrated flow rate to be multiplied by a reported time duration value to determine a content amount value.

At 1106, a new amount of content remaining in the container that was holding the dispensed content is determined. For example, the determined amount of content dispensed is subtracted from a previous recorded amount of content remaining in the container to determine and record the new amount of content remaining in the container.

At 1108, an action is performed based on the one or more determined amounts. For example, inventory tracking and automatic inventory replenishment are performed. As the amount poured is computed the dispensed amount is subtracted from a tracked remaining amount/inventory. Associated depletions of entire containers/kegs and inventory replenishments can also be tracked.

In some embodiments, an inventory of a beverage remaining in an opened/consumed/installed container as well as new containers stocked on hand are tracked to provide a reporting of consumption amounts, cost of goods sold, consumption pattern, inventory forecasting, etc.

In some embodiments, performing the action includes providing an alert when it is detected that inventory of the content is low. For example, a mobile application alert on an interface device is provided when the amount/level of content reaches below a threshold value for a single container and/or an inventory across all inventory on hand of the content. In another example, the alert is provided on the sensor device (e.g., flashing light). In some embodiments, the alert is only provided if the amount/level of content reaches below a threshold value. The threshold value may be dynamically determined based on a historical depletion pattern of the content. In some embodiments, an interface device application and/or a webpage is utilized to display and manage inventory of content.

In some embodiments, a database tracks remaining content in each container tracked by a sensor device, and for each tracked content, stores one or more of the following: sensor device identifier, type of liquid, brand of product, UPC, bar code identifier, quantity remaining, quantity utilized over a time period (e.g., minute/day/week/month/year, etc.), new product container on hand, price, distributor, date and time of purchase, servings per use, time of servings consumed, location, expiration, chemical composition, odor, color, temperature, humidity, ingredients of the content, and various content composition information (e.g., sulfites, ethyl, etc.). This may result in tracking millions of sensor devices and provided measurement data at any given point in time. In some embodiments, once sufficient fill values are collected over time, performing the action includes determining a recommended time to reorder, a rate of consumption, an average amount consumed per pour/usage, etc. In some embodiments, a user is able to establish and specify one or more inventory thresholds based on product category, brand, type of beverage, cost, and/or recipes. For example, when the inventory of a product falls below a threshold, a notification may be provided in real-time. Consumption and/or inventory data may be tracked per each individual user/consumer, establishment, business, distributor, account, brand, and/or geographical region.

In some embodiments, performing the action includes obtaining Point of Sale data of items (e.g., mixed drinks, shots, glasses, etc.) sold and correlating the POS data with tracked content inventory depletion. This may offer a view into which types of beverages are in demand, how beverages are consumed, and pairing between different products (e.g., food pairing). Based on this information, a user entity profile may be developed to enable insights into past performance and future forecasting of the user entity's sales metrics. In some embodiments, by analyzing consumption patterns across user entities, geographical regional analysis may be performed to analyze product trends. This information may be utilized to provide recommendations on items to offer for sale based on seasonality, real-time consumption data, and trends for a particular geographical area as well as across a larger region.

In some embodiments, performing the action includes aggregating values of a plurality of content dispense events (e.g., aggregating values associated with amounts of content dispensed or aggregating the plurality of content dispense events as a single content dispense event) and associating it with a single transaction/event. For example, a bartender may actuate a content dispense mechanism multiple times to fill a single pint glass of drink with pauses in between to allow foam of the drink to settle. To account for this, values of one or more subsequent content dispense events that occur within a threshold length amount of time (e.g., in some embodiments between each subsequent content dispense event, or within all of the content events to be aggregated in other embodiments) are aggregated together and accounted as a corresponding to a single transaction/event. A determination of whether to aggregate values of content dispense events may also be made based on an amount of content dispensed in the content dispense events. For example, only values of subsequent content dispense events that occur within a threshold length amount of time and for which the total sum amount of content dispensed is less than a limit value are aggregated together and associated with the single transaction. In another example, only values of subsequent content dispense events that occur within a threshold length amount of time and for which the total sum amount of content dispensed is within a specified range are aggregated together and associated with the single transaction.

The combination of the POS data and the types and quantities of beverages sold, a view into which types of beverages are in demand, how is it consumed, and paired with other products (e.g., food) offered can be analyzed and reported. Based on this information a “Profile” can be developed for a user which offers insights into how the user business is operating in terms of beverage consumption, ordering, and future demand. Based on the analysis of various beverage consumption patterns across the country, regional analysis of beverage consumption can be offered. Such data could then be offered to various establishments based on the geography to help them make informed choices on the beverages to be offered (e.g., which are in demand), which helps them maximize their revenue. In some embodiments, one or more of the following functionalities are provided:
ability to track the beverage consumption by content, brand, and various categorization per period (e.g., minute/day/week/month).
ability to associate the sales of various types of beverages paired with the food by connecting to the POS in real-time.
ability to build a “Profile” of a bar by combining the consumption pattern with the POS data.
ability to aggregate beverage consumption patterns across various geographies.
ability to make recommendations about possible ways to maximize revenue by offering a certain type of beverage or recipe based on seasonality, consumption in real-time, and geographical trends.

In some embodiments, performing the action includes assisting in ordering additional quantities of the content being tracked. For example, the consumption amount and pattern of the content and amount of full product containers on hand are analyzed to determine how many additional containers of the content should be ordered to replenish the stock inventory of the container. In some embodiments, the order for additional product containers may be automatically provided to a preferred or preset distributor/merchant/sales representative of the product container to automatically place an order for the content. For example, a user is provided an option to reorder a product from a distributor by allowing the user to automatically send inventory reports periodically to the distributor. In some embodiments, a notification to order additional quantities of a product/content is provided to a user and the user may provide an associated confirmation to automatically place an order for the recommended additional quantities of the product/content from a recommended/preset distributor. Order configuration such as distributor preference, payment information, preferred time of delivery, etc. may be stored and utilized when automatically placing an order. This may allow “one-tap” reorder, where once the reorder notification is tapped on a user interface, series of these services are initiated in the background and the desired product is delivered on time at the preferred location without any further reordering action from the user.

In some embodiments, a mobile application is utilized to provide queries for information related to the consumer. The application may then display the food availability, various notifications such as reordering, health improvements, recipe recommendations, and food persona (e.g., nutrient analytics) of the consumer. In various embodiments, the mobile application is utilized to provide one tap food reordering that helps users get the food delivered to their preferred location and preferred time without any further action. In some embodiments, the mobile application provides access to a delivery services marketplace that offers the user a choice to choose from a host of delivery services. When a user gets a notification to re-order a certain product, the user may tap on the mobile device notification to confirm the re-order and the item would be automatically delivered to their preferred physical address from their preferred source without any further action or steps from the consumer. When the user downloads the mobile application or subscribes to the analysis and tracking services, user preferences on delivery address, payments, and preferred time of delivery may be received and stored. Various delivery service options (e.g., Amazon Fresh, Google Shopping Express, Instacart, other food marketplaces, local farmers, etc.) may be aggregated. A consumer's preference for the delivery service may be stored alongside payment, delivery location, and delivery time preferences. In some embodiments, once the reorder notification is indicated, a one or more of services are initiated in the background and the product is delivered at the time and location as specified without any further action from the consumer.

In some embodiments, a product marketplace with various distributor/merchant options for products is accessible via a device (e.g., user device 112 and/or interface device 106 of FIG. 1). In some embodiments, a device/server is able to locate a distributor's delivery truck or service that is nearby and automatically order/request delivery of one or more products/containers that are preferred to be restocked immediately. For example, when it is detected that additional quantity of a product is required prior to a normal product ordering/delivery schedule, immediate delivery from a nearby source is automatically requested. A user may be provided a notification prior to ordering/delivery to obtain authorization from the user.

In some embodiments, an analysis system tracks products stocked by a user. In some embodiments, a mobile application tracks the current location of the user using the GPS locations provided by a mobile device (e.g., smartphone, tablet, wearable computer, etc.). The information of whether a certain food item is running low or about to expire and the current location of a user device are utilized to offer recommendations to pick those food and beverages when the user location is nearby a merchant that carries the food and beverage. In some embodiments, the mobile application locates a user's presence in or near a store and detects that the user is running low on a specific food item and notifies the user to pick up the food item while at the store.

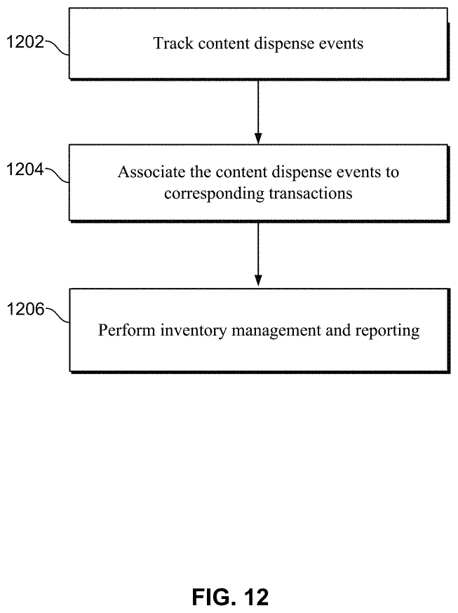

FIG. 12 is a flowchart illustrating an embodiment of a process for performing inventory management and reporting. The process of FIG. 12 may be at least in part implemented on interface device 106 and/or server 110 of FIG. 1. In some embodiments, at least a portion of the process of FIG. 12 is performed in 1108 of FIG. 11.

At 1202, content dispense events are tracked. For example, when (e.g., time value) and amount of liquid poured for each content dispense event from a container is tracked. For example, the amounts of content dispensed determined in 1104 are tracked for various different products. When, what, and how much content level is changed for each content item being tracked can be tracked and stored as a list of content fill level change event entries. The content fill level change event entries can be aggregated per each individual user/consumer, establishment, business, distributor, account, brand, and/or geographical region.

At 1204, the content dispense events are associated to corresponding transactions. For example, point of sale (POS) transaction information is correlated with the content fill level change events. This may allow identification of any of the content dispense events that are unable to be matched to a correlating POS transaction, allowing identification of any unauthorized content dispense event. The correlation may be performed by identifying an item sold in a transaction, determining type and amount of component ingredient(s) of the sold item, and matching the component ingredient(s) to one or more corresponding entries in the content dispense events based at least in part on matching associated time values.

In some embodiments, a plurality of content dispense events corresponds to a single transaction/event and values of the plurality of content dispense events are aggregated together (e.g., aggregating values associated with amounts of content dispensed or aggregating the plurality of content dispense events as a single content dispense event) and associated with the single transaction/event. For example, a bartender may actuate a content dispense mechanism multiple times to fill a single pint glass of drink with pauses in between to allow foam of the drink to settle. To account for this, values of one or more subsequent content dispense events that occur within a threshold length amount of time (e.g., in some embodiments between each subsequent content dispense event, or within all of the content events to be aggregated in other embodiments) are aggregated together and accounted as a corresponding to a single transaction/event. A determination of whether to aggregate values of content dispense events may also be made based on an amount of content dispensed in the content dispense events. For example, only values of subsequent content dispense events that occur within a threshold length amount of time and for which the total sum amount of content dispensed is less than a limit value are aggregated together and associated with the single transaction. In another example, only values of subsequent content dispense events that occur within a threshold length amount of time and for which the total sum amount of content dispensed is within a specified range are aggregated together and associated with the single transaction.

At 1206, inventory management and reporting is performed. For example, bars and restaurants sell beer and other beverages. At the end of the business day one can use the data of all sales and compute the total quantity of what was poured out by the container, brand and aggregate. The total actual amount of product utilized/poured to make sold drink products could be different from theoretical amounts that were supposed to be utilized to make sold drink products due to various reasons. There could have been over pours or under pours compared to the expected, actual drinks made might not have been recorded as a sale, and another brand of a similar type of beverage could have been substituted for what was recorded as sold, etc.

Results of the correlation between the content dispense events and the corresponding transactions, information, reports, and/or alerts on amounts of content dispensed and/or amounts of content over/under dispensed from the theoretical amount of content that should have been dispensed (e.g., over pour, under pour, etc.) aggregated per specific content item, transaction, product (e.g., drink product including many component ingredients), fill level change event, container, brand, type, category, entity location, geographical region, time period, employee (e.g., bartender), and/or content consumer are provided along with calculated performance scores or metric values. Thus not only does the inventory management system automatically track fill level of containers and amount of inventory of remaining full containers, each content dispense event (e.g., indicating content, time of content dispense event and amount) is tracked along with statistics on fill change as compared to the amount of sold content. This may also allow a user to not only track sales popularity and patterns across various metrics (e.g., by item, transaction, content dispense event, product, container, brand, type, category, entity location, geographical region, time period, employee, content consumer, etc.) but also identify and investigate unexpected content losses (e.g., review a report of content dispense events not attributed to a corresponding sale).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A device, comprising:
a coupling component configured to be coupled to a moveable component of a content dispensing mechanism;
a sensor configured to detect movement of the content dispensing mechanism;
a processor configured to:
based at least in part on the detected movement of the content dispensing mechanism, determine one or more values corresponding to an amount of content dispensed by the content dispensing mechanism; and
a wireless signal transmitter configured to report the one or more values corresponding to the amount of content dispensed by the content dispensing mechanism.

2. The device of claim 1, wherein the content dispensing mechanism is a beverage dispenser faucet.

3. The device of claim 1, wherein the moveable component of the content dispensing mechanism is a lever.

4. The device of claim 1, wherein the coupling component includes an opening through which a portion of the moveable component is inserted.

5. The device of claim 1, wherein the coupling component is coupled to the content dispensing mechanism between a lever collar and a handle component of the content dispensing mechanism.

6. The device of claim 1, wherein the coupling component is screwed onto a threaded portion of the moveable component.

7. The device of claim 1, wherein the coupling component is a handle component of the content dispensing mechanism.

8. The device of claim 1, wherein the sensor is an accelerometer.

9. The device of claim 1, wherein the sensor is one or more of the following: a gyroscope, an orientation sensor, a tilt sensor, or a switch.

10. The device of claim 1, further comprising a clock component configured to be utilized in determining a time duration associated with the detected movement.

11. The device of claim 1, further comprising a battery.

12. The device of claim 1, wherein the processor is configured to determine value including by being configured to detect that a position associated with the detected movement meets a triggering threshold corresponding to dispensing of the content from the content dispensing mechanism.

13. The device of claim 12, wherein the position is an orientation angle.

14. The device of claim 1, wherein the one or more values includes a time duration while the moveable component was within a range of positions corresponding to dispensing of the content from the content dispensing mechanism.

15. The device of claim 1, wherein the one or more values includes a time duration value for each of different detected positions within a range of positions corresponding to dispensing of the content from the content dispensing mechanism.

16. The device of claim 1, wherein the one or more values includes a volume value.

17. The device of claim 1, wherein the reported one or more values are utilized to determine a volume amount of content dispensed during a content dispense event and track an amount of content remaining in a container from which the content was dispensed.

18. The device of claim 17, wherein the tracked amount of content in the container is utilized to automatically order a product of the container when the tracked amount is below a configurable threshold.

19. The device of claim 1, wherein the reported one or more values are aggregated with one or more previously reported values and associated with a single content dispense transaction.

20. A method, comprising:
detecting using a sensor device coupled to a moveable component of a content dispensing mechanism movement of the moveable component;
based at least in part on the detected movement of the content dispensing mechanism, determining one or more values corresponding to an amount of content dispensed by the content dispensing mechanism; and
reporting via a wireless signal, the one or more values corresponding to the amount of content dispensed by the content dispensing mechanism.

21. A method, comprising:
receiving from a sensor device coupled to a moveable component of a content dispensing mechanism movement, one or more values corresponding to an amount of content dispensed by the content dispensing mechanism, wherein the one or more values were determined by the sensor device based at least in part on a detected movement of the moveable component;
calculating a volume value corresponding to the received one or more values; and
determining an amount of content remaining in a container from which the content was dispensed.
